(19) United States
(12) Patent Application Publication
(10) Pub. No.: US 2025/0300217 A1
(43) Pub. Date: Sep. 25, 2025

(54) SODIUM-ION ENERGY STORAGE APPARATUS

(71) Applicant: Power Ahead Group, Inc, Boulder, CO (US)

(72) Inventors: Yong ZHANG, Richmond (CA); Yunru ZHANG, Shanghai (CN); Huiyan LI, Shanghai (CN); Faxing MA, Shanghai (CN); Cunbiao LI, Richmond (CA); Quanying ZHANG, Shanghai (CN)

(73) Assignee: Power Ahead Group, Inc, Boulder, CO (US)

(21) Appl. No.: 19/083,525

(22) Filed: Mar. 19, 2025

(30) Foreign Application Priority Data
Mar. 25, 2024 (CN) 202410343707.6

(51) Int. Cl. H01M 10/054; H01M 4/02; H01M 4/36; H01M 4/485; H01M 4/58; H01M 4/587

(52) U.S. Cl. CPC H01M 10/054; H01M 4/366; H01M 4/485; H01M 4/5825; H01M 4/587; H01M 2004/021; H01M 2004/027; H01M 2004/028

(57) ABSTRACT

A sodium-ion energy storage apparatus is provided, including: a positive electrode, a negative electrode, a separator, and an electrolyte; a positive electrode active material of the positive electrode includes Ce₁₋ₓMₓO₂, M is at least one metal and 0.01≤x≤0.25; and a negative electrode active material of the negative electrode includes a sodium source that generates sodium ions. The positive electrode of the present disclosure uses Ce₁₋ₓMₓO₂ obtained by doping CeO₂ with the metal M as the positive electrode, and the capacity is increased by two to three times compared to undoping.

### CROSS REFERENCE TO THE RELATED APPLICATIONS

This application is based upon and claims priority to Chinese Patent Application No. 202410343707.6, filed on Mar. 25, 2024, the entire contents of which are incorporated herein by reference.

### TECHNICAL FIELD

The present disclosure relates to the technical field of energy storage, specifically to a sodium-ion energy storage apparatus.

### BACKGROUND

In recent years, from the perspective of protecting the earthly environment and effectively utilizing energy with the goal of conserving resources, electric power smoothing systems or nighttime electric power storage systems for wind power generation, decentralized electric power storage systems for household use based on solar power generation technologies, electric power storage systems for electric vehicles and the like receive much attention.

The requirement for batteries used in these electric power storage systems is high energy density. As a strong candidate for the high energy density batteries that may meet such a requirement, the lithium-ion secondary batteries have been widely developed and promoted due to their energy density exceeding 100 Wh/L and their excellent durability, including long cycle life. Consequently, they have become the preferred energy storage element for electric vehicles, mobile devices, and other high-capacity applications.

However, the average concentration of key lithium in the earth's crust is only around 20 ppm, and lithium production is geographically constrained. If the lithium-ion secondary batteries continue to gain widespread adoption in the future, concerns regarding lithium resource depletion would arise. Therefore, alternative materials, particularly more abundant alkali metals such as sodium or potassium, are being actively explored for use in energy storage applications.

### SUMMARY

To address the limitations of existing technologies, the present disclosure provides a sodium-ion energy storage apparatus.

The present disclosure discloses a sodium-ion energy storage apparatus, including: a positive electrode, a negative electrode, a separator, and an electrolyte; a positive electrode active material of the positive electrode includes Ce₁₋ₓMₓO₂, M is at least one metal and 0.01≤x≤0.25; and a negative electrode active material of the negative electrode includes a sodium source that generates sodium ions.

As a further improvement of the present disclosure, a partition x of Ce is substituted by the doped metal M, and the position of Ce in a crystal structure of a cerium dioxide provided is occupied. However, at least one lattice parameter of the crystal structure may be corrected by doping with the dopant metal M. However, for other dopants, the dopant metal M may occupy different positions in the crystal structure, while the location of Ce may remain empty; and thus, the positive electrode active material may improve the safety of electrochemical energy storage devices on the one hand, and improve the performance of the electrochemical energy storage devices on the other hand, especially in terms of energy density, particularly power density.

As a further improvement of the present disclosure, the electrolyte contains a sodium salt selected from sodium nitrate, sodium chloride, sodium sulfate, sodium phosphate, sodium acetate, sodium citrate, sodium hydroxide, or mixtures thereof, and pH of the electrolyte is in the range of about 1 to about 13.

As a further improvement of the present disclosure, the negative electrode active material includes layered sodium transition metal oxide and sodium transition metal phosphate.

As a further improvement of the present disclosure, the negative electrode active material includes at least one of Na₃V₂(PO₄)₃, Na₃Fe₂(PO₄)₃, and Na₃Fe₃(PO₄)₄.

As a further improvement of the present disclosure, M is selected from Al, Ti, V, Cr, Mn, Fe, Co, Ni, Sn, Cu, Zn, Nb, Mo, In, Sn, W, and Bi, and further M is selected from Fe, Co, and Bi.

As a further improvement of the present disclosure, 0.05≤x≤0.15, further preferably 0.07≤x≤0.12, and most preferably x is 0.1.

As a further improvement of the present disclosure, the particle size of the positive electrode active material and the negative electrode active material is 1-100 nm, preferably 8-20 nm.

As a further improvement of the present disclosure, the weight proportion of Ce₁₋ₓMₓO₂ in the positive electrode active material is not less than 50%, and the weight proportion of the sodium source in the negative electrode active material is not less than 50%.

As a further improvement of the present disclosure, at least one of the positive electrode active material and the negative electrode active material is coated with carbon.

As a further improvement of the present disclosure, the coated carbonaceous material includes: carbon black, graphite, graphene, activated carbon, carbon fiber, carbon nanofiber, carbon nanotube, carbon nanoparticle, crystalline carbon, semi-crystalline carbon, amorphous carbon or mixtures thereof, and the coated carbonaceous material is formed by the decomposition of hydrocarbons containing an organic compound, an organic-inorganic compound, an organic-metallic compound, a polymer or mixtures thereof.

As a further improvement of the present disclosure, a preparation method for the positive electrode active material includes the following operations.

A dopant precursor is provided, herein the dopant precursor includes CeO₂ and metal M; the dopant precursor is dissolved in an aqueous solvent, to obtain solution, and pH of the solution is adjusted to pH≥10; the temperature of the solution is raised to 100-300° C.; the solution is cooled to a room temperature, as to obtain a precipitate, herein the precipitate is the positive electrode active material containing Ce₁₋ₓMₓO₂. On this basis, it further includes: a carbon coated positive electrode active material.

In order to apply a carbon coating layer, the organic compound, preferably selected from one or more natural sugars such as glucose, sucrose, maltose, or cellulose, or derivatives thereof, may be dissolved in suitable solvents, such as water in the presence of the glucose or sucrose, or ionic liquid in the presence of the cellulose. The doped cerium dioxide compound Ce₁₋ₓMₓO₂ may be suspended therein. A suspension obtained may preferably withstand a further elevated temperature of 150° C. to 200° C. Especially, a further obtained precipitate that may be collected by centrifugation may be preferably subjected to a further drying process. Subsequently, the dry precipitate may be subjected to heat treatment at a higher temperature ranging from 250° C. to 600° C., preferably 300° C. to 500° C., especially about 400° C., to ultimately obtain a composite including the carbon coated doped cerium dioxide compound Ce₁₋ₓMₓO₂.

As a further improvement of the present disclosure, a preparation method for the negative electrode active material may be performed by using the same method as described above; for example, Na₃Fe₂(PO₄)₃ is mixed with sucrose in water. A mixture is heated in Ar at 700° C. for 4 h, to obtain carbon coated sodium-iron phosphate; after carbon is coated with the sucrose, Na₃Fe₂(PO₄)₃ may disappear due to the reduction of Fe and transform from ³⁺ to FE²⁺, it causes a change in crystal structure. NA₃Fe₂(PO₄)₃ is prepared by oxidizing a carbon coated sample in air at 300° C. for 6 h.

Compared with the existing technologies, the beneficial effects of the present disclosure are as follows.

The positive electrode of the present disclosure uses Ce₁₋ₓMₓO₂ obtained by doping CeO₂ with the metal M as the positive electrode, and the capacity is increased by two to three times compared to undoping; at the same time, the carbon coating layer on the positive electrode may improve the available specific capacity, cycle stability, and rate capability of the sodium-ion batteries, it has great potential for high-power batteries and may achieve discharging and charging within less than a few minutes; and Na₃Fe₃(PO₄)₄, due to its unique layered structure, may achieve a double electron reaction in charging and discharging processes and has good rate performance.

### BRIEF DESCRIPTION OF THE DRAWINGS

FIG. 1 is an X-ray diffraction (XRD) analysis diagram between CeO₂ and Ce₁₋ₓMₓO₂, herein M is Fe, Co, and Bi respectively.

FIG. 2 is a constant current cycle diagram of an electrode between CeO₂ and Ce₁₋ₓMₓO₂, herein M is Fe, Co, Bi, Mn, Nb, or Ti respectively.

FIG. 3 is a constant current cycle of the electrode between CeO₂ and Ce₁₋ₓMₓO₂ at an increased specific current, and subsequently the current is decreased back to 100 mA g⁻¹; herein, M is Fe, Co, Bi, Mn, Nb or Ti respectively.

FIG. 4 is a constant current cycle of CeO₂ and Ce₁₋ₓMₓO₂ based electrode, herein M is Fe, Co, Bi, Mn, Nb, or Ti respectively, as a positive electrode active material for sodium-ion battery applications.

FIG. 5 is comparison of XRD analysis between CeO₂, Ce_{0.9}Fe_{0.1}O₂, and carbon coated Ce_{0.9}Fe_{0.1}O₂—C.

FIGS. 6A-6B are constant current cycle of electrodes based on CeO₂, Ce_{0.9}Fe_{0.1}O₂, and carbon coated Ce_{0.9}Fe_{0.1}O₂—C respectively as the positive electrode active material for sodium-ion battery applications, and the constant current (FIG. 6A) and the increased specific current before subsequently decreasing the current back to 100 mA g⁻¹ (FIG. 6B) are applied.

### DETAILED DESCRIPTION OF THE EMBODIMENTS

In order to make purposes, technical schemes, and advantages of embodiments of the present disclosure clearer, the technical schemes in the embodiments of the present disclosure are clearly and completely described below in combination with drawings in the embodiments of the present disclosure. Apparently, the embodiments described are a part of the embodiments of the present disclosure, not all of the embodiments. Based on the embodiments of the present disclosure, all other embodiments obtained by those of ordinary skill in the art without creative labor shall fall within the scope of protection of the present disclosure.

The present disclosure is further described in detail below in combination with the drawings.

### Embodiment 1

Pure undoped CeO₂ and Ce_{0.9}M_{0.1}O₂ were synthesized by using a mild hydrothermal synthesis method as known references in existing technologies, M=Fe, Co, Bi. For this reason, 9 mmol of Ce(NO₃)₃·6H₂O and 1 mmol of corresponding dopant precursor Fe(NO)₃ were mixed, and 5 M of NaOH was dropwise added to solution under continuous stirring so that pH was adjusted to 13. The solution obtained was further stirred for 1 h, then transferred to a stainless steel high-pressure kettle, and withstood a temperature of 200° C. for 24 h under continuous stirring at 1000 rpm. After being cooled to a room temperature, a precipitate was washed for several times with deionized water and ethanol, and dried at 60° C. Without adding any dopant precursors, the pure undoped CeO₂ was synthesized by using the same method.

In order to provide a carbon coating layer, 1.2 g of glucose was dissolved in 80 mL of deionized water before adding 600 mg of Ce_{0.9}M_{0.1}O₂ as the corresponding positive electrode active material under continuous stirring. A suspension obtained was transferred to the stainless steel high-pressure kettle, and placed at 180° C. for 13 h under stirring at 1000 rpm. A precipitate was collected by centrifugation, washed for several times with deionized water and ethanol, and finally dried overnight at 60° C. Subsequently, the dry composite material was subjected to 2 h of heat treatment at 400° C. under an argon atmosphere in a heating rate of 3° C. min⁻¹.

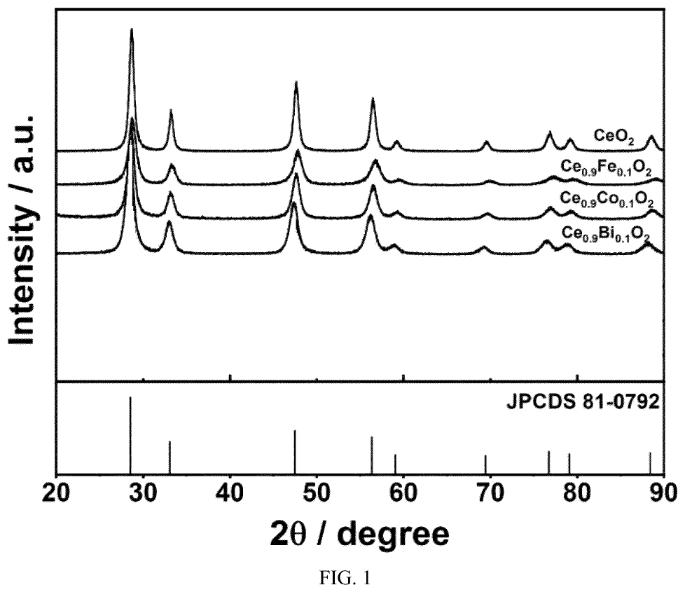

All materials synthesized are preliminarily represented by X-ray diffraction (XRD) and transmission electron microscopy (TEM). The diffraction diagram shown in FIG. 1 reveals the successful synthesis of the pure phase material in all cases; in addition, the introduction of various dopants has a significant impact on the average microcrystalline size, as shown in Table 1 below.

TABLE 1

| Positive electrode active material | Average particle size | |
|---|---|---|
| CeO₂ | 131 | Å |
| Ce_{0.9}Fe_{0.1}O₂ | 82 | Å |
| Ce_{0.9}Co_{0.1}O₂ | 88 | Å |
| Ce_{0.9}Bi_{0.1}O₂ | 77 | Å |

From Table 1, it may be seen that the introduction of Bi, Co, and Fe leads to the significant reduction in grain size.

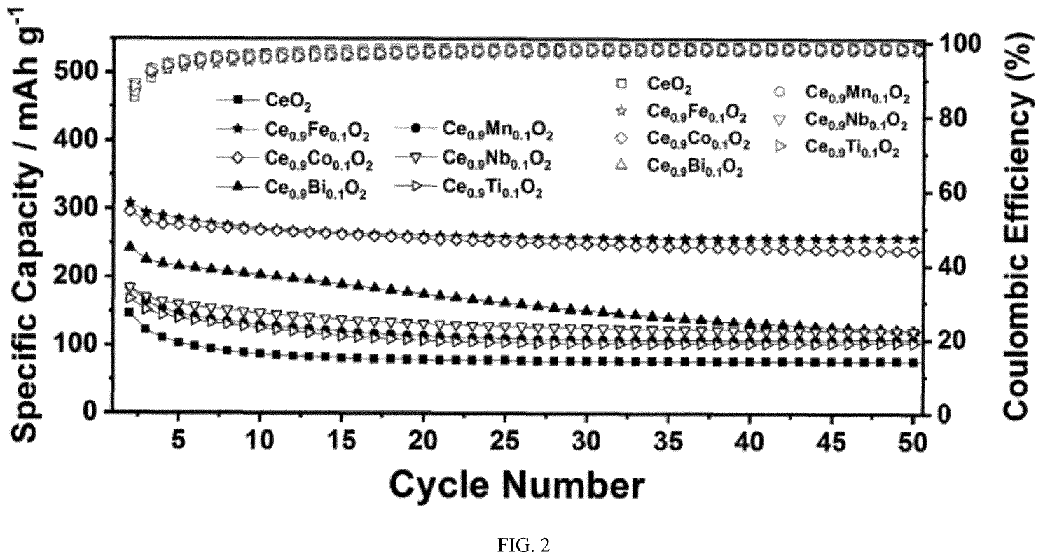

As shown in FIG. 2, the results obtained indicate that the properties of the dopants play a decisive role in the achievable capacity. Ce_{0.9}Fe_{0.1}O₂, Ce_{0.9}Co_{0.1}O₂, and Ce_{0.9}Bi_{0.1}O₂ all show significant improvements compared to CeO₂.

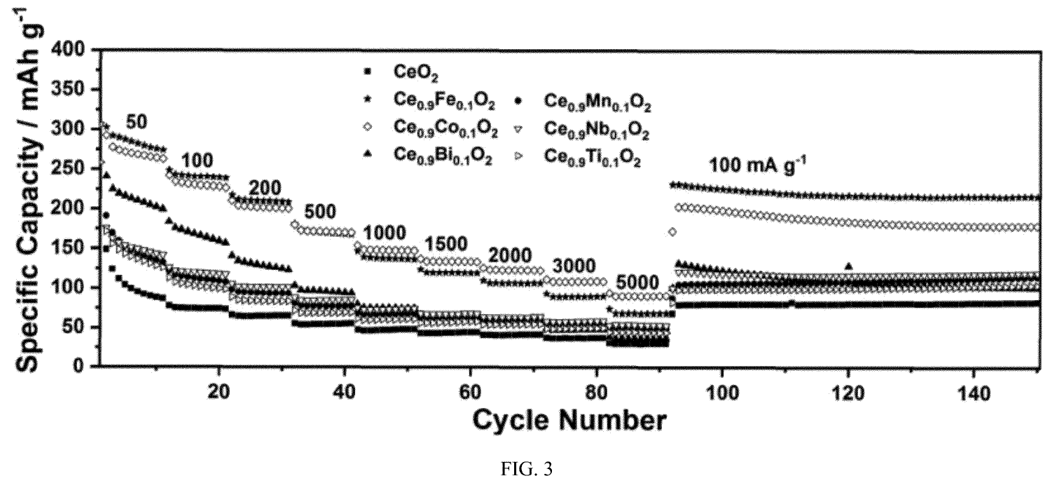

As shown in FIG. 3, before subsequently reducing the current back to 100 mA g⁻¹, the increased capacity of Ce_{0.9}Fe_{0.1}O₂, Ce_{0.9}Co_{0.1}O₂, and Ce_{0.9}Bi_{0.1}O₂ is also maintained when the increased specific current is applied.

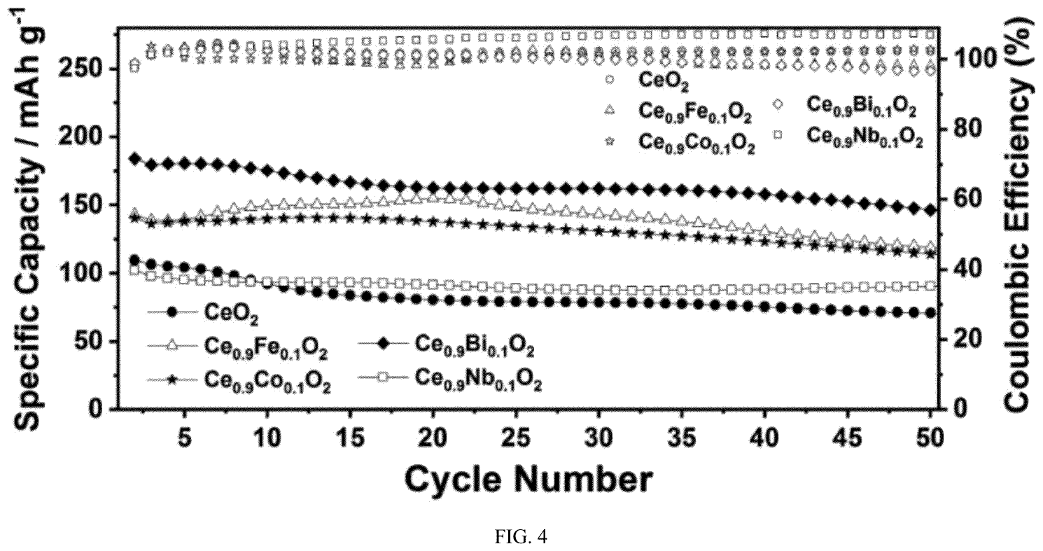

The potential usage of Ce_{0.9}M_{0.1}O₂ and M=Fe, Co, Bi in the sodium-ion battery applications is researched by using the constant current cycle. As shown in FIG. 4, in this case, the doping of Fe and Co also leads to a significant increase in capacity of about 47 mAhg⁻¹ and 43 mAhg⁻¹ respectively, namely it is increased by about 50% compared to pure undoped CeO₂. In addition, it is worth noting that the Ce_{0.9}Bi_{0.1}O₂ sample shows a further increased capacity value, it is approximately twice greater than the value obtained from the pure undoped CeO₂.

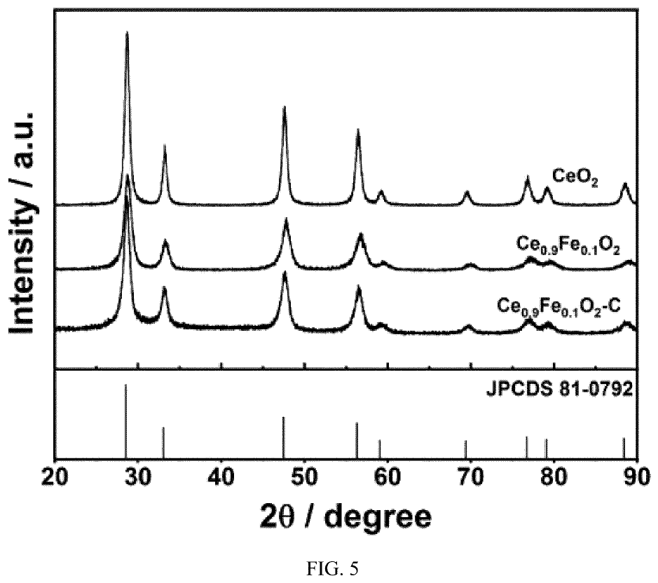

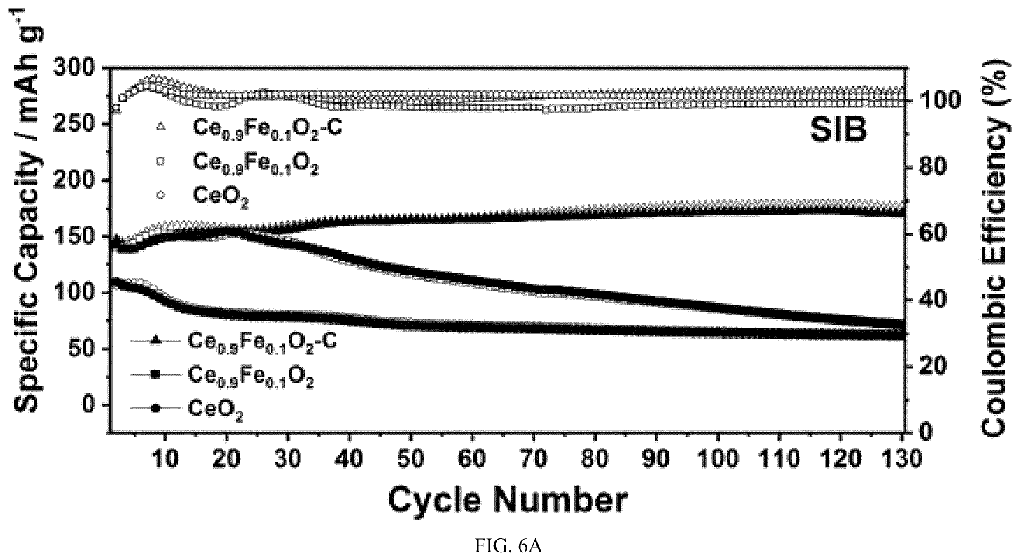

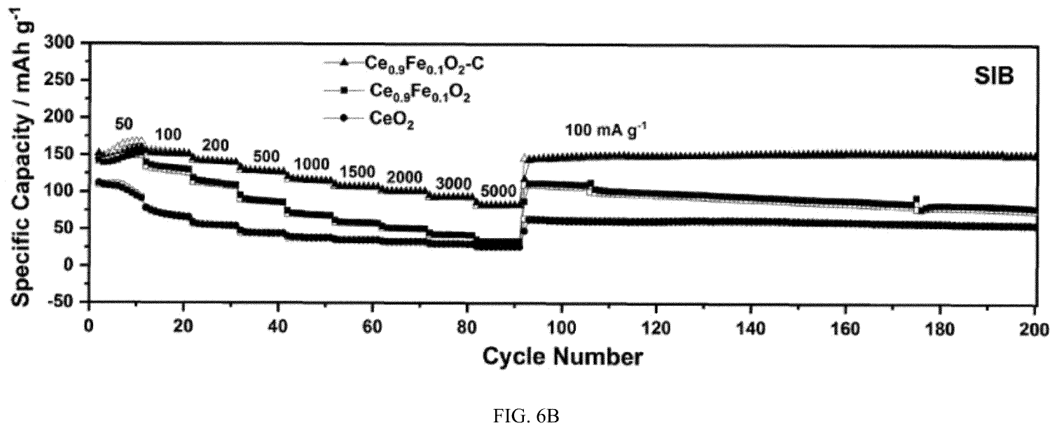

In addition, carbon coated Ce_{0.9}Fe_{0.1}O₂—C is synthesized for sodium-ion battery applications. The XRD representation shown in FIG. 5 indicates that the application of the carbon coating layer does not affect the crystal structure, while a TEM micrograph (unshown here) shows the presence of a thin carbon layer in about 5 nm thickness on Ce_{0.9}Fe_{0.1}O₂—C nanoparticles. An electrode based on the carbon coated positive electrode active material is tested, and data is compared with uncoated sample and pure undoped CeO₂, as shown in FIGS. 6A-6B, this has a beneficial impact on the achievable capacity of lithium-ion applications and sodium-ion applications at different discharging/charging rates.

FIGS. 6A-6B show the constant current cycle of electrodes based on CeO₂, Ce_{0.9}Fe_{0.1}O₂, and carbon coated Ce_{0.9}Fe_{0.1}O_{2-C} as the negative electrode active material for sodium-ion battery applications. The constant current is applied (FIG. 6A), and then the constant current cycle is performed at the increased specific current before subsequently reducing the current back to 100 mA g⁻¹ (FIG. 6B). The specific current applied in FIG. 6A is 50 mA g⁻¹, while the cut-off voltages in FIGS. 6A-6B are 0.01 and 3.0 V respectively (relative to Na/Na⁺). Especially, when it is cycled with metallic sodium, the carbon coating layer also supports the significantly improved cycle stability, as shown in FIG. 6A.

Na₃Fe₃(PO₄)₄, due to its unique layered structure, may achieve a double electron reaction in charging and discharging processes and has good rate performance. The reversible specific capacity in the first cycle is 83 mAh/g, and at a current density of 200 C, the capacity still remains at 42 mAh/g (equivalent to being able to fully charge 50% of the battery in 9 s). In addition, this material also has good cycle performance, and the capacity retention rate is still 72% after 6000 cycles.

The above are only preferred embodiments of the present disclosure and are not intended to limit the present disclosure. For those skilled in the art, the present disclosure may have various modifications and variations. Any modifications, equivalent replacements, improvements and the like made within the spirit and principles of the present disclosure shall be contained within the scope of protection of the present disclosure.

What is claimed is:

1. A sodium-ion energy storage apparatus, comprising: a positive electrode, a negative electrode, a separator, and an electrolyte; wherein a positive electrode active material of the positive electrode comprises Ce₁₋ₓMₓO₂, M is at least one metal, and 0.01≤x≤0.25; and a negative electrode active material of the negative electrode comprises a sodium source, and the sodium source generates sodium ions.

2. The sodium-ion energy storage apparatus according to claim 1, wherein the negative electrode active material comprises a layered sodium transition metal oxide and a sodium transition metal phosphate.

3. The sodium-ion energy storage apparatus according to claim 2, wherein the negative electrode active material comprises at least one of Na₃V₂(PO₄)₃, Na₃Fe₂(PO₄)₃, and Na₃Fe₃(PO₄)₄.

4. The sodium-ion energy storage apparatus according to claim 1, wherein M is selected from Fe, Co, and Bi.

5. The sodium-ion energy storage apparatus according to claim 1, wherein 0.05≤x≤0.15.

6. The sodium-ion energy storage apparatus according to claim 5, wherein x is 0.1.

7. The sodium-ion energy storage apparatus according to claim 1, wherein a particle size of each of the positive electrode active material and the negative electrode active material is 8-20 nm.

8. The sodium-ion energy storage apparatus according to claim 1, wherein a weight proportion of the Ce₁₋ₓMₓO₂ in the positive electrode active material is not less than 50%, and a weight proportion of the sodium source in the negative electrode active material is not less than 50%.

9. The sodium-ion energy storage apparatus according to claim 1, wherein at least one of the positive electrode active material and the negative electrode active material is coated with a carbonaceous material.

10. The sodium-ion energy storage apparatus according to claim 9, wherein the carbonaceous material comprises: a carbon black, a graphite, a graphene, an activated carbon, a carbon fiber, a carbon nanofiber, a carbon nanotube, a carbon nanoparticle, a crystalline carbon, a semi-crystalline carbon, an amorphous carbon, or mixtures thereof, and the carbonaceous material is formed by a decomposition of hydrocarbons comprising an organic compound, an organic-inorganic compound, an organic-metallic compound, a polymer, or mixtures thereof.
